(19) United States
(12) Patent Application Publication
(10) Pub. No.: US 2008/0225337 A1
(43) Pub. Date: Sep. 18, 2008

(54) INFORMATION PROCESSING DEVICE, PROGRAM, AND RECORDING MEDIUM

(76) Inventor: Nahoko YANO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/045,195

(22) Filed: Mar. 10, 2008

(30) Foreign Application Priority Data
Mar. 15, 2007 (JP) 2007-066760

(51) Int. Cl. G06F 15/00

(52) U.S. Cl. 358/1.16

(57) ABSTRACT

An information processing device includes a storing unit in which registered medium information is stored, indicating a set of registered recording media uses, which uses are permitted by the information processing device. A checking unit checks usability of a removable recording medium attached to the information processing device by comparing the registered medium information with registered device information acquired from the recording medium attached to the information processing device and indicating a set of registered information processing devices, each of which permits use of the recording medium in the registered information processing device. A usability control unit manages use of the recording medium in the information processing device according to a result of the checking.

### BACKGROUND OF THE INVENTION

1. Field of the Invention

This invention generally relates to an information processing device which uses a removable recording medium, and more particularly to an information processing device which manages use of a removable recording medium in the information processing device.

2. Description of the Related Art

In recent years, there are provided general-purpose removable recording media which include a SD (SecureDigital, registered trademark) memory card, a USB flash memory, etc. The recording medium is removably attached to an information processing device, such as a personal computer (PC), and used for reading data from the recording medium or for writing data generated by the information processing device to the recording medium.

Also in recent years, an application program and user data are stored in a removable recording medium, and the program and the data are read from the recording medium in an image forming device, such as a multi-function peripheral. The program is used in the image forming device to perform addition, updating, and functional expansion of the program or firmware, and the user data is read and used by the application program in the image forming device.

For example, Japanese Laid-Open Patent Application No. 2006-279935 discloses an information processing device related to the function expansion using a removable recording medium. In order to perform management by the license of a removable recording medium in which actual information containing a program for adding a predetermined function is stored, this information processing device is adapted so that the license information recorded on the recording medium is compared with the license information stored in the information processing device itself, to determine whether use of the actual information recorded on the recording medium is permitted according to a result of the comparison.

In a conventional method of managing a removable recording medium, in order to permit use of a removable recording medium for general purposes, a special management which restricts a range of use of the recording medium is not performed but any information processing device is allowed to use the recording medium without checking identification of the recording medium. The recording medium is allowed to be attached to any information processing device without checking identification of the device.

The conventional method provides the user with convenience of use of removable recording media and information processing devices. However, when confidential data are recorded on removable recording media, the conventional method will allow any person to make use of the confidential data easily. Accordingly, the conventional method has a data security problem.

Moreover, the above-mentioned conventional method is intended to control the permission of execution of the program stored in the recording medium according to a result of the comparison of license information, thereby preventing the unauthorized re-use of the program for another information processing device. However, the conventional method does not work to restrict the range of use of the recording medium itself, and does not prevent the user from taking out data from the recoding media. In addition, the management of license information according to the above-mentioned conventional method has no restriction to the addition of other license information, and the above-mentioned conventional method has a data security problem.

### SUMMARY OF THE INVENTION

According to one aspect of the invention, an improved information processing device is disclosed in which the above-described problems are eliminated.

According to another aspect of the invention an information processing device is disclosed which is adapted for performing access control of a removable recording medium depending on a permission of use of the recording medium given by association between the information processing device and the recording medium, and for managing use of the recording medium in the information processing device with a high level of security.

In an embodiment of the invention which solves or reduces one or more of the above-mentioned problems, an information processing device is disclosed which uses a removable recording medium, the information processing device comprising: a storing unit in which registered medium information, indicating a set of registered recording media use of which in the information processing device is permitted, is stored; a checking unit for checking usability of a removable recording medium attached to the information processing device by comparing the registered medium information from the storing unit with registered device information acquired from the recording medium attached to the information processing device and indicating a set of registered information processing devices each of which permits use of the recording medium in the registered information processing device; and a usability control unit managing use of the recording medium in the information processing device according to a result of the checking by the checking unit.

The above-mentioned information processing device may be arranged so that the checking unit retrieves a device identifier of the information processing device from the acquired registered device information and sets the result of the checking to indicate the permission of use of the recording medium when the device identifier is found.

The above-mentioned information processing device may be arranged so that the checking unit retrieves a medium identifier of the recording medium acquired from the recording medium, from the registered medium information from the storing unit, and sets the result of the checking to indicate the permission of use of the recording medium when the medium identifier is found.

The above-mentioned information processing device may be arranged so that the usability control unit permits reading data from the recording medium or writing data to the recording medium when the result of the checking is set to indicate the permission of use of the recording medium.

The above-mentioned information processing device may be arranged to further comprise a reading unit reading a predetermined data from the recording medium when the result of the checking is set to indicate the permission of use of the recording medium.

The above-mentioned information processing device may be arranged to further comprise a managing unit adding a medium identifier of the recording medium to the registered medium information and writing a device identifier of the information processing device to the recording medium, so that an association process is performed to associate the recording medium with the information processing device.

The above-mentioned information processing device may be arranged so that the managing unit is arranged to determine whether the association process is to be performed, by using at least one of an upper limit of the number of the registered information processing devices and an upper limit of the number of the registered recording media.

The above-mentioned information processing device may be arranged so that the managing unit is arranged to delete a medium identifier of the recording medium from the registered medium information and delete a device identifier of the information processing device from the recording medium, so that association cancelling process is performed to cancel association of the recording medium from the information processing device.

The above-mentioned information processing device may be arranged to further comprise an authority information storing unit in which authority management information relating to authority of execution of a process by the managing unit is stored, and an authority managing unit which determines whether execution of the process by the managing unit is permitted, according to the authority management information.

In an embodiment of the invention which solves or reduces one or more of the above-mentioned problems, a multi-function peripheral is disclosed which uses a removable recording medium, the multi-function peripheral comprising: a storing unit in which registered medium information is stored indicating a set of registered recording media, use of which in the multi-function peripheral is permitted; a checking unit checking usability of a removable recording medium attached to the multi-function peripheral, by comparing the registered medium information from the storing unit with registered device information, acquired from the recording medium attached to the multi-function peripheral and indicating a set of registered multi-function peripherals, each of which permits use of the recording medium in the registered multi-function peripheral; and a usability control unit managing use of the recording medium in the multi-function peripheral according to a result of the checking by the checking unit.

In an embodiment of the invention which solves or reduces one or more of the above-mentioned problems, an information processing method is disclosed for an information processing device which uses a removable recording medium, the method comprising: storing registered medium information, indicating a set of registered recording media, use of which in the information processing device is permitted, into the information processing device; checking usability of a removable recording medium attached to the information processing device, by comparing the registered medium information with registered device information acquired from the recording medium attached to the information processing device and indicating a set of registered information processing devices, each of which permits use of the recording medium in the registered information processing device; and managing use of the recording medium in the information processing device according to a result of the checking.

According to the embodiments of the information processing device of the invention, it is possible to perform access control of a removable recording medium depending on the permission of use of the recording medium given by association between the information processing device and the recording medium, to manage use of the recording medium in the information processing device with a high level of security.

### BRIEF DESCRIPTION OF THE DRAWINGS

Other objects, features and advantages of the present invention will be apparent from the following detailed description when reading in conjunction with the accompanying drawings.

FIG. 1 is a block diagram showing the hardware composition of an image forming device in an embodiment of the invention.

FIG. 2 is a block diagram showing the software composition of the image forming device of this embodiment.

FIG. 3 is a diagram showing the data structure of device side checking information and medium side checking information.

FIG. 4 is a flowchart showing a license checking process which is performed by the image forming device of this embodiment.

FIG. 5 is a flowchart showing an access control which is performed by the image forming device of this embodiment.

FIG. 6 is a diagram showing an example of a graphical user interface which is displayed on an operation panel unit.

FIG. 7 is a flowchart showing a license management process which is performed by the image forming device of this embodiment.

FIG. 8 is a diagram showing the data structure of a user authority table.

FIG. 9 is a flowchart showing an association process which is performed by the image forming device of this embodiment.

FIG. 10 is a flowchart showing an association cancelling process which is performed by the image forming device of this embodiment.

FIG. 11 is a diagram showing an example of a graphical user interface for setting up the upper limit of the number of devices which can be registered in a recording medium and the upper limit of the number of recording media which can be registered in the image forming device of the invention.

### DETAILED DESCRIPTION OF PREFERRED EMBODIMENTS

A description will now be given of embodiments of the invention with reference to the accompanying drawings.

As a typical example of an information processing device in an embodiment of the invention, an image forming device 10 which has multiple image-forming functions including a copier function, a facsimile function, a scanner function, a printer function, etc. will be described in the following. The image forming device 10 may be called a multi-function peripheral.

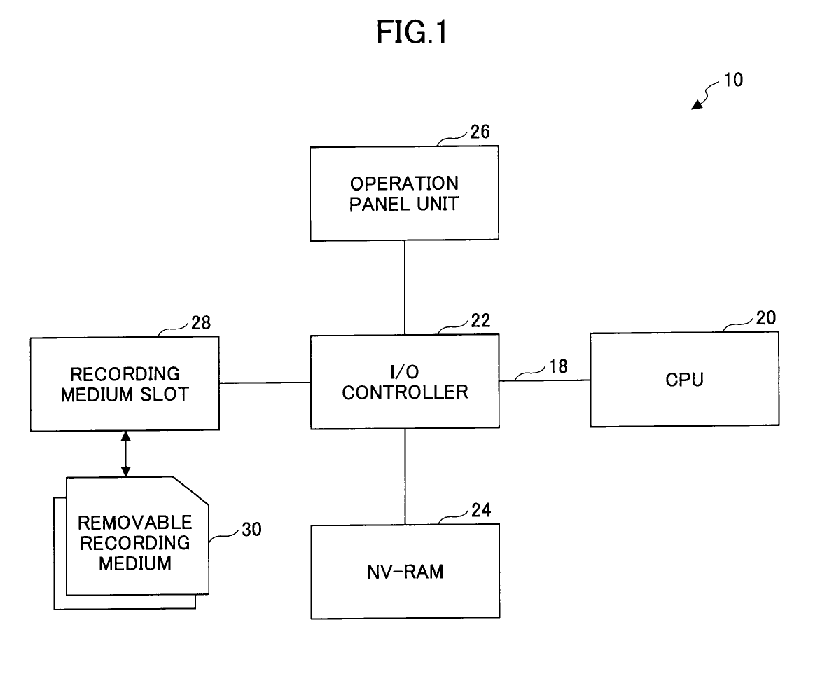

FIG. 1 shows the hardware composition of the image forming device 10 in an embodiment of the invention. The image forming device 10 of this embodiment is arranged to include a CPU (central processing unit) 20, an I/O controller 22 connected to the CPU 20 via a bus 18, a nonvolatile memory (NV-RAM) 24, an operation panel unit 26, and an SD card slot 28 (which is a recording medium slot which may be referred to as the slot).

The NV-RAM 24 stores the control program executed by the image forming device 10, the system information of the image forming device 10, etc. Moreover, the NV-RAM 24 stores registered medium information containing a device identifier of this image forming device 10 and medium identifiers of a set of recording media each, of which is allowed to be used in this image forming device 10, setting information containing an upper limit of the number of registered recording media which are allowed to be used therein, and authority management information, which will be mentioned later.

The operation panel unit 26 is connected to the I/O controller 22 and arranged to include a display and an input device which are not illustrated. The operation panel unit 26 receives various instructions from the operator and outputs an operational screen to the display, which provides a user interface.

The slot 28 is connected to the I/O controller 22 and arranged to enable attachment and detachment of an SD card 30 (which is a removable recording medium which may be referred to as the recording medium 30) to and from the image forming device 10. The slot 28 performs reading and writing of data from and to the recording medium 30. For example, in the recording medium 30 which is attached to the slot 28, the control program of the image forming device 10, such as firmware, and the user data used in the image forming device 10, such as address book, image data, text data, etc. may be stored.

The I/O controller 22 performs the input/output control of the NV-RAM 24 and the recording medium 30, and the input/output control of the operation panel unit 26.

Moreover, the image forming device 10 of this embodiment is arranged to include the hardware for performing the multi-function peripheral function, such as FCU (facsimile control unit) and engine unit, the network I/F, such as network interface card (NIC), the USB I/F for connecting the device 10 with an external PC, etc., and the interfaces conforming to the standard interfaces, such as IEEE 1394 I/F and Centronics I/F, which are not illustrated.

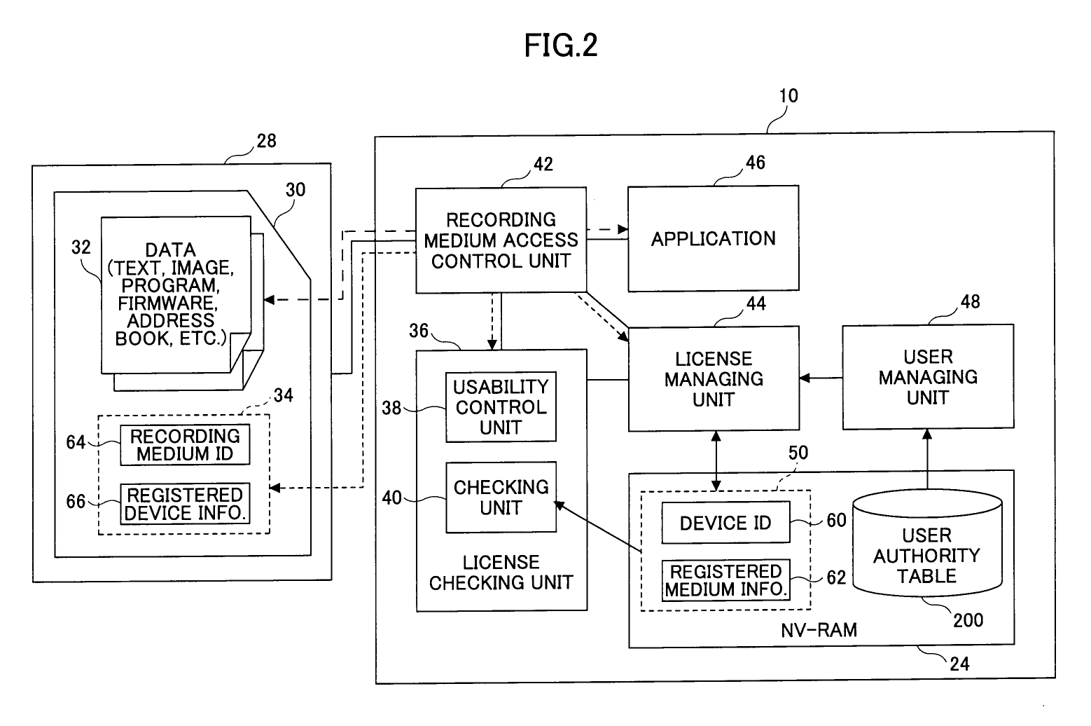

FIG. 2 shows the software composition of the image forming device of this embodiment.

The image forming device 10 is arranged to include a license checking unit 36, a recording medium access control unit 42, a license managing unit 44, and an application 46. The recording medium 30, which is used with the image forming device 10 of this embodiment, stores a medium identifier 64 of the recording medium 30, and registered device information 66 indicating a set of registered information processing devices, each of which permits use of the recording medium 30 in the registered information processing device when the recording medium 30 is attached thereto. These items of information are used as management data at the time of license checking of the recording medium 30. In the recording medium 30, the actual data 32 (text, image, program, firmware, address book, etc.) which is used by the image forming device 10 are stored as well.

For the sake of simplicity of description, the medium identifier 64 and the registered device information 66 which are stored in the recording medium 30 will be collectively referred to as medium side checking information 34.

The recording medium access control unit 42 performs access control of the recording medium 30, and manages the permission of access to the medium side checking information 34 and the permission of access to the storage area in which the actual data 32 are stored.

The recording medium access control unit 42 is configured to receive an interrupt signal output from the slot 28 when the recording medium 30 is attached to the slot 28 or detached from the slot 28, and is configured to detect attachment or detachment of the recording medium 30 in response to the interrupt signal.

The license checking unit 36 is arranged to include a checking unit 40 and a usability control unit 38. A device identifier 60 of the image forming device 10 and registered medium information 62 containing medium identifiers of a set of registered recording media use of which in the image forming device 10 is permitted are stored in the NV-RAM 24 provided in the image forming device 10.

For the sake of simplicity of description, the device identifier 60 and the registered medium information 62, which are stored in the image forming device 10, will be collectively referred to as device side checking information 50.

The checking unit 40 acquires the medium side checking information 34 from the recording medium 30, and compares the acquired medium side checking information 34 with the above-mentioned device side checking information 50. The checking unit 40 determines whether the recording medium 30 attached to the image forming device 10 is a recording medium, use of which in the image forming device 10 is permitted, and sets the result of the checking to a value indicating the “permission of use” or a value indicating the “non-permission of use”.

In the following, for the sake of simplicity of description, this process performed by the checking unit 40 in the present embodiment will be called “license checking”. What is meant by the recording medium 30 having a license is that use of the recording medium 30 in the image forming device 10 is permitted. What is meant by the recording medium 30 having no license is that use of the recording medium 30 in the image forming device 10 is not permitted.

When the result of the checking is set to the value indicating the “permission of use” by the checking unit 40, the usability control unit 38 verifies the condition of partition or a file system in the recording medium 30 if needed, and shifts the recording medium 30 to an enable condition as a file system, and sends a notification about the enable condition of the recording medium 30 to the recording medium access control unit 42.

On the other hand, when the result of checking is set to the value indicating the “non-permission of use”, the usability control unit 38 shifts the recording medium 30 to a disable condition in which the recording medium 30 cannot be used, and sends a notification about the disable condition of the recording medium 30 to the recording medium access control unit 42.

In response to this notification, the recording medium access control unit 42 controls the permission of access to the storage area of the recording medium 30 in which the actual data 32 are stored (which will be referred to as actual storage area).

In the present embodiment, use of the recording medium means accessing the actual storage area in the recording medium, that is, performing writing data to or reading data from the recording medium. For example, according to UNIX® system, control of the permission of use of the recording medium 30 may be performed by a “mount” process to shift the recording medium 30 from a disable condition to an enable condition or by an “unmount” process to shift the recording medium 30 from an enable condition to a disable condition.

The license managing unit 44 performs any of association process to associate the image forming device 10 and the recording medium 30, association cancelling process to cancel the association, and setting process to set the upper limit of the number of devices or the upper limit of the number of media which can be registered by association, etc., and performs license management of the recording medium 30 with respect to the image forming device 10.

In the present embodiment, a license is given to the recording medium 30 through the association process, and use of the recording medium 30 in the image forming device 10 is permitted.

The license given to the recording medium 30 is cancelled through the association cancelling process, and use of the recording medium 30 in the image forming device 10 is prohibited.

The application 46 is a function unit which reads the actual data 32 from the recording medium 30, or writes data held or generated by the image forming device 10 to the recording medium 30 as the actual data 32. The application 46 issues an access request to the recording medium 30.

The application 46 may be performed by any of a file manager, an image-data or text-data viewer, a print application to print a stored image data, a mailer using an address book, a fax application, etc.

In an alternative embodiment, the application 46 may be replaced by a firmware stored in the recording medium 30 or a program starting unit to start execution of a program.

The access requests generated from the license checking unit 36 and the license managing unit 44 which use the medium side checking information 34, are indicated by the dotted lines in FIG. 2.

The recording medium access control unit 42 issues a predetermined control instruction, and controls reading of the medium identifier 64 and the registered device information 66 from the recording medium 30, and writing of data to the recording medium 30. The access requests generated from the application 46 using the actual data 32 are indicated by the dashed lines in FIG. 2. With respect to the access request (the dashed line) to the actual data 32, the recording medium access control unit 42 receives a notification from the usability control unit 38, and controls the permission of access according to the result of the checking by the checking unit 40.

The image forming device 10 of this embodiment is arranged to further include a user managing unit 48. The user managing unit 48 authenticates the user who uses the image forming device 10, and determines the authority of the user to perform the above-mentioned license management process.

In the NV-RAM 24, a user authority table 200 which associates user identifiers and user authority levels is stored. The user managing unit 48 retrieves the user authority table 200, when a command of execution of the license management process is input by the user on the operation panel unit 26, and determines whether the user has the authority to perform the process. The user managing unit 48 controls the permission of execution of the process.

In the image forming device 10 shown in FIG. 1 and FIG. 2, the control program is read from the memory device, such as ROM, HDD (which are not illustrated), the NV-RAM 24, and the recording medium 30, and developed to the memory area, such as RAM which is not illustrated and provides the work area of the CPU 20. Under the management control of the OS (operating system), the above-mentioned software unit and the below-mentioned process are performed through the development of the control program.

In addition, the UNIX® operating system (OS) is adopted as the OS of the image forming device 10. The WINDOWS®, OS and any other OS may also be used.

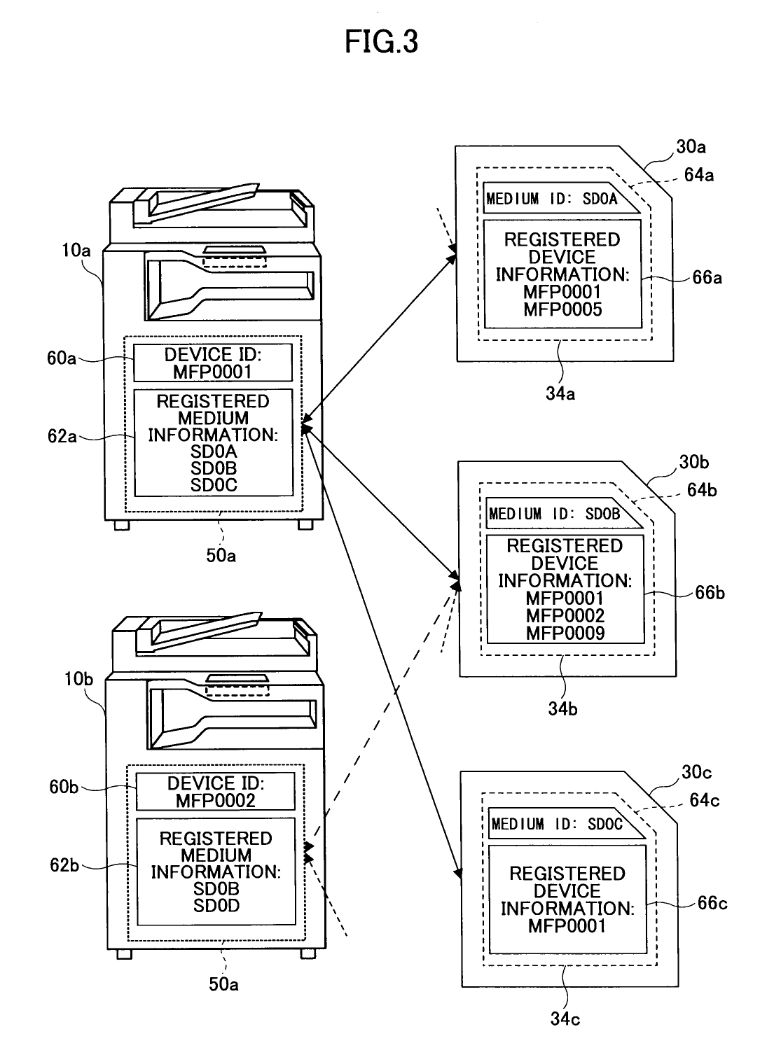

FIG. 3 shows the data structure of the medium side checking information which is stored in each of the recording media and the device side checking information, which is stored in the image forming device of this embodiment.

As shown in FIG. 3, the image forming device 10a and the image forming device 10b hold device side checking information 50a and device side checking information 50b, respectively. In the device side checking information 50a and 50b, device identifiers (device ID) 60a and 60b which identify the respective image forming devices 10a and 10b, and registered medium information 62a and 62b, each of which includes medium identifiers of a set of registered recording media associated with the image forming devices 10 and 10b are included, respectively.

As shown in FIG. 3, the recording media 30a-30c hold medium side checking information 34a-34c, respectively. In the medium side checking information 34a-34c, medium identifiers (medium ID) 64a-64c which identify the respective recording media 30a-30c, and registered device information 66a-66c, each of which includes device identifiers of a set of registered information processing devices associated with the recording media 30a-30c are included, respectively.

For another example, the image forming device 10a in the embodiment of FIG. 3 holds the device ID 60a “MFT0001” which identifies the image forming device 10a, and the registered medium information 62a which includes a set of medium ID “SD0A”, “SD0B”, and “SD0C” of the registered recording media associated with the image forming device 10a.

For example, the recording medium 30a in the embodiment of FIG. 3 holds the medium ID 34a “SD0A” which identifies the recording medium 30a, and the registered device information 66a which includes the device ID “MFT0001” and “MFT0005” of the registered information processing devices associated with the recording medium 30a.

That is, the image forming device 10a holds the data entry of the medium ID of the recording medium 30a in the registered medium information 62a, the recording medium 30a holds the data entry of the device ID of the image forming device 10a in the registered device information 66a, the device identifier of the image forming device 10a and the medium identifier of the recording medium 30a are shared and associated with each other.

As shown in FIG. 3, the data entry of null or more corresponding identifiers is held in the registered medium information 62 and the registered device information 66. The number of the identifiers contained in each of the registered medium information 62 and the registered device information 66 is below a predetermined upper limit.

The checking unit 40 of this embodiment reads the medium ID 64 and the registered device information 66 from the recording medium 30 attached to the image forming device 10, and acquires the medium side checking information 34 therefrom. By using the device ID 60 of the image forming device 10 as a search key, the checking unit 40 retrieves a corresponding device ID from the registered device information 66. When the device ID 60 is found, the checking unit 40 sets the result of the checking to indicate an affirmative judgment.

By using the medium ID 64 of the recording medium 30 as a search key, the checking unit 40 retrieves a corresponding medium ID from the registered medium information 62. When the medium ID 64 is found, the checking unit 40 sets the result of the checking to indicate an affirmative judgment.

In the license checking of the present embodiment, it is detected whether at least one of the device ID and the medium ID is shared by the image forming device 10 and the recording medium 30, and, when it is detected that either is shared, it is determined that the use of the recording medium 30 in the image forming device 10 is permitted. However, the present invention is not limited to the above-described embodiment.

Alternatively, according to the level of security required, the license checking may be carried out by detecting that both the device identifier (device ID) and the medium identifier (medium ID) are shared. Alternatively, implementation of the license checking may be performed to suit a specific application, so that the recording medium 30 holds only the medium ID 64 and the checking unit 40 performs the license checking using only the registered medium information 62.

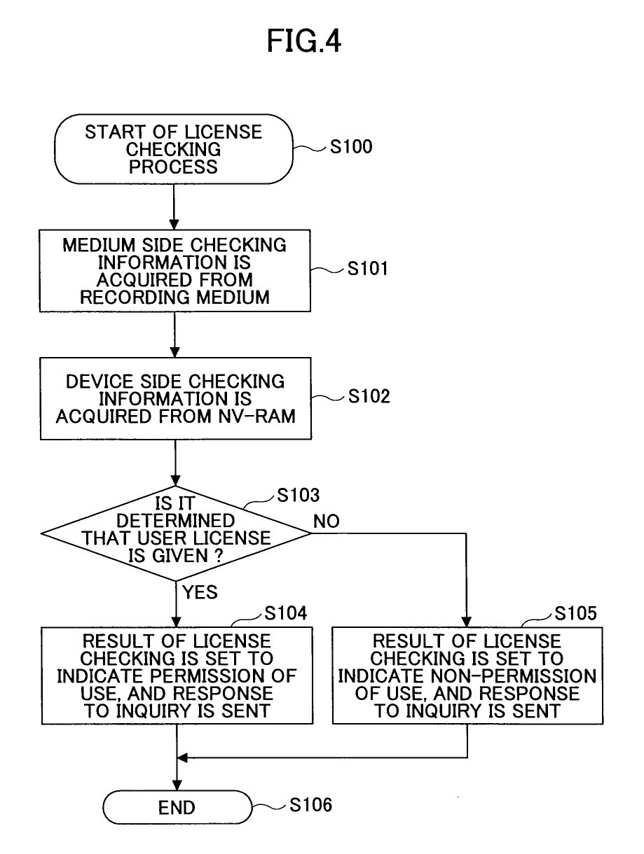

Next, a description will be given of a license checking process. FIG. 4 is a flowchart for explaining a license checking process which is performed by the image forming device of this embodiment.

The license checking process of FIG. 4 is started at step S100 when the checking unit 40 receives an inquiry of license checking. For example, the inquiry of license checking is forwarded by the recording medium access control unit 42 when attachment of the recording medium 30 is detected or when occurrence of an access request is detected.

At step S101, the checking unit 40 acquires the medium side checking information 34 from the recording medium 30 and stores it in a predetermined storage area, such as a memory area.

At step S102, the checking unit 40 acquires the device side checking information 50 stored in the NV-RAM 24 and stores it in a predetermined storage area, such as a memory area.

At step S103, the checking unit 40 compares the acquired medium side checking information 34 and the acquired device side checking information 50, and determines whether at least one of the device ID and the medium ID is shared by the image forming device 10 and the recording medium 30. In this manner, the checking unit 40 performs the license checking of the recording medium 30 attached to the image forming device 10.

When it is determined at step S103 that at least one of the device ID and the medium ID is shared and the recording medium 30 has a license (YES), the process is shifted to step S104. At step S104, the checking unit 40 sets the result of the checking to indicate the permission of use of the recording medium 30, and transmits the result of the checking as a response to the inquiry. The process is terminated at step S106.

On the other hand, when it is determined at step S103 that none of the device ID and the medium ID is shared and the recording medium 30 has no license (NO), the process is shifted to step S105. At step S105, the checking unit 40 sets the result of the checking to indicate non-permission of use of the recording medium 30, and transmits the result of the checking as a response to the inquiry. In this case, the process is terminated at step S106.

Next, the control of the permission of use of the recording medium 30 and the access control according to the result of the checking will be explained.

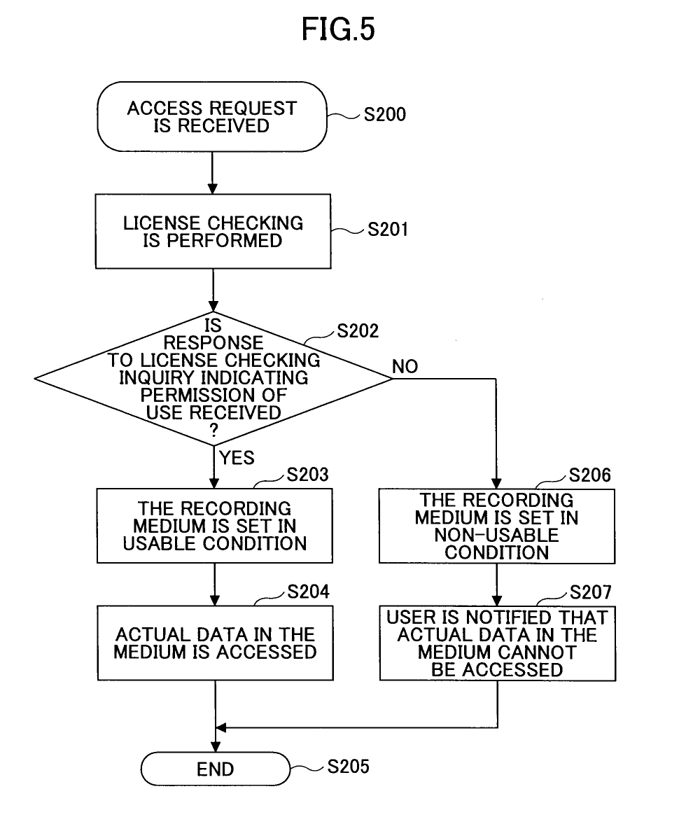

FIG. 5 is a flowchart showing the access control which is performed by the image forming device of this embodiment.

The access control shown in FIG. 5 is performed in response to a request for accessing the actual storage area of the recording medium 30. The access control process of FIG. 5 is started at step S200 when an access request for accessing the actual data 32 of the recording medium 30 is received from the application 46 or other applications.

At step S201, the recording medium access control unit 42 transmits an inquiry of license checking to the license checking unit 36, and license checking of the recording medium 30 is performed by the checking unit 40.

At step S202, the usability control unit 38 determines whether the result of the checking from the checking unit 40 (or the response to the inquiry) is set to indicate the permission of use of the recording medium 30. When it is determined at step S202 that the result of the checking is set to indicate the permission of use of the recording medium 30 (YES), the process is shifted to step S203.

At step S203, the usability control unit 38 performs verification of partitions or a file system in the recording medium 30 if needed, sets the recording medium 30 in a usable condition, and notifies the recording medium access control unit 42 that the recording medium 30 is set in a usable condition.

At step S204, the recording medium access control unit 42 receives the notification from the usability control unit 38, permits access to the actual data 32 in the recording medium 30, and performs accessing of the requested data in the recording medium 30. The recording medium access control unit 42 transmits the corresponding notification to the application 46 as a response to the access request. The process is terminated at step S205.

On the other hand, when it is determined at step S202 that the result of the checking is set to indicate the non-permission of use of the recording medium 30 (NO), the process is shifted to step S206. At step S206, the usability control unit 38 sets the recording medium 30 in a non-usable condition, and notifies the recording medium access control unit 42 that the recording medium 30 is set in a non-usable condition.

At step S207, the recording medium access control unit 42 receives the notification from the usability control unit 38, rejects access to the actual data 32 in the recording medium 30, and notifies the application 46 that the access request is rejected. The recording medium access control unit 42 causes the operation panel unit 26 to display a screen indicating that the requested data cannot be accessed, which is notified to the user. The process is terminated at step S205.

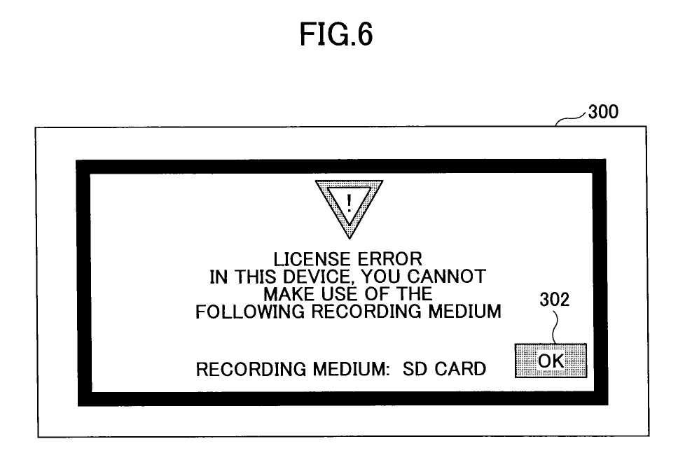

FIG. 6 shows an example of a graphical user interface (GUI) which is displayed on the operation panel unit 26 at step S207 in the access control process of FIG. 5, when access to the actual data of the recording medium 30 is rejected.

The GUI 300 shown in FIG. 6 contains a message indicating that an SD card for which the access request for accessing the actual data therein is transmitted cannot be used due to a license error, and an OK button 302 for confirming the message.

As mentioned above, it is possible for the present embodiment to suppress use of a recording medium which is not yet associated with the information processing device, by means of the composition which controls the permission of use of the recording medium and controls access to the actual data in the recording medium according to the result of license checking.

In a case of a recording medium 30 which is properly associated with the information processing device, the application 46 is permitted to access the actual storage area of the recording medium 30. The application 46 can read out the actual data 32 from the recording medium 30 to make use of it, and can write the data created by the application 46 to the recording medium 30.

When the actual data 32 stored in the recording medium 30 is text data (TXT, DOC, RTF, etc.), image data (JPEG, BMP, PNG, GIF, etc.), or print formal data (PS, EPS, PDF, etc.), any of the following operations may be performed by the image forming device 10: (1) displaying a thumbnail, a filename or text information on the display of the operation panel unit 26; (2) performing the printing of the read data by using the print application, or (3) performing FAX transmission by using the facsimile application.

When the actual data 32 stored in the recording medium 30 is user data, such as an address book, the image forming device 10 may transmit the data which is stored in a storage device, such as a HDD (which is not illustrated), by using the contents of the address book via FAX transmission or via a network.

When the actual data 32 stored in the recording medium 30 is an application program, the image forming device 10 may perform function expansion of the image forming device 10 with the application program by initiating a predetermined firmware program, and may start the application program, such as a dictionary or a game. The present invention is not limited to these applications and it is applicable to the composition in conformity with a specific application.

The license checking and the control of the permission of use of the recording medium by the license checking unit 36 may be performed every time an access request occurs, from a viewpoint of security. However, the present invention is not limited to the above-mentioned embodiment. Alternatively, the recording medium access control unit 42 may transmit an inquiry to the license checking unit 36 upon receipt of an interrupt signal from the slot 28 at the time of attaching the recording medium 30 thereto, and the license checking unit 36 may control the permission of use of the recording medium 30. Subsequently, the recording medium access control unit 42 receives the notification from the license checking unit 36, and holds the status of the permission on the memory area as the status value, so that the status value is held and the permission of access is determined by making reference to the status value, until removal of the recording medium 30 is detected, the association is cancelled, or the recording medium 30 is unmounted by the timeout of a predetermined period of time.

When attachment of the recording medium 30 is detected and control of use permission is started, the recording medium 30 is set in a usable condition, and simultaneously it may notify the data utilizing unit, such as the application 46 or a program starting unit. For example, a file system stored in the recording medium 30, such as a general purpose ROM file system in “gz” compression format in UNIX®, may be mounted further. Furthermore, the data stored in the recording medium 30 may be searched so that the actual data 32 is automatically read out from the recording medium 30.

Moreover, the image forming device 10 of this embodiment may also perform license management for every program data stored in the recording medium 30, and may perform electronic authentication to the actual data 32 in the recording medium 30.

Alternatively, the usability control unit 38 in another embodiment of the invention may be arranged to set the recording medium 30 in a read-only usable condition, so that the recording medium 30 is usable only for reading data from the recording medium 30. Also, information of an optional operation may be included in the device side checking information 50 or the medium side checking information 34, so that control the permission of use of the recording medium 30 can be performed in a fine-grained manner.

Next, a description will be given of license management process which is performed by the image forming device 10 of this embodiment. In this embodiment, a user authority is checked for the license management process, including the association process, the association cancelling process, and the setting change process with respect to an upper limit of the number of information processing devices which can be registered to the recording medium, and an upper limit of the number of recording media which can be registered to the image forming device, and the permission of the execution of the license management process is determined.

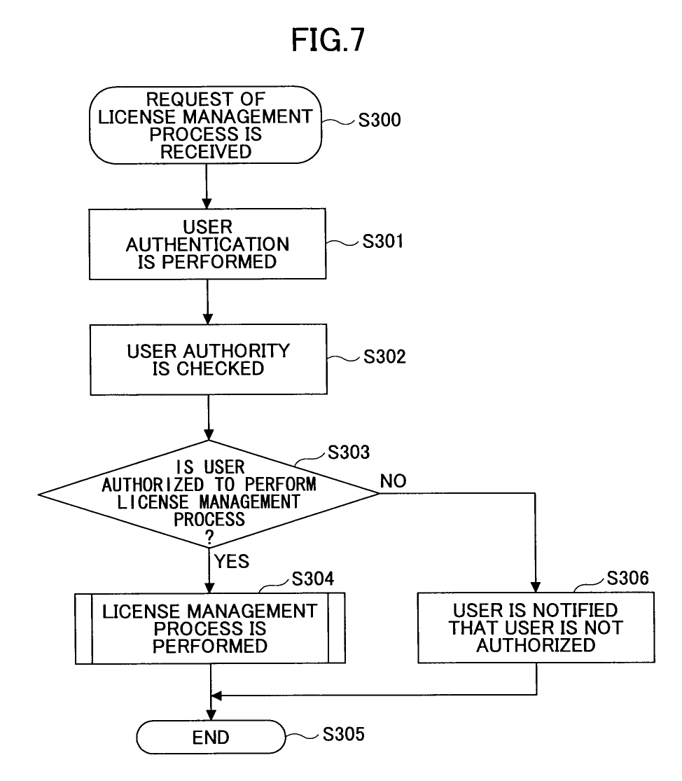

FIG. 7 is a flowchart showing a license management process which is performed by the image forming device of this embodiment.

For example, the license management processing of FIG. 7 is started at step S300 when a request for execution of the license management process input by a user on the operation panel unit 26 is received.

At step S301, the user managing unit 48 performs user authentication. For example, in this user authentication, the prompt screen of a user identifier and a password is displayed on the operation panel unit 26, and it is determined whether the user is an authorized user, based on the user identifier and the password which are entered by the user.

To the authenticated user, at step S302, a user authority over the requested process is checked by making reference to the user authority table 200. The user authority table 200 will be explained in more detail below.

At step S303, it is determined whether the user has the execution authority over the requested process requested. When it is determined that the user has the authority (YES), the process is shifted to step S304.

At step S304, the user managing unit 48 sends the notification to the license managing unit 44 and causes the license managing unit 44 to perform the requested license management process. At step S305, the process is terminated.

On the other hand, when it is determined at step S303 that the user has no execution authority over the requested process (NO), the process is shifted to step S306. At step S306, the user is notified through the operation panel unit 26 that the user has no authority to perform the requested process, and the process is terminated at step S305.

As mentioned above, the user authority over the process is checked (S302) prior to causing the license management process to be performed (S304), and the control (S306) rejects the process execution by the user who has no authority. Accordingly, it is possible to reduce a possibility that an unauthorized user perform the association process freely.

The user authentication of step S301 may be performed upon occurrence of every license management process request in order to raise security. Alternatively, the process of step S301 may be omitted by performing user authentication beforehand.

As a method for performing the above-mentioned user authentication, any kind of user authentication method, such as BASIC authentication or DIGEST authentication, may be used. In the composition of the system containing a network interface card (NIC), etc., the authentication method through a network, such as Windows® authentication through a domain controller of Windows® which is connected via the network, and LDAP (Lightweight Directory Access Protocol) authentication through an LDAP server which is connected via the network, may be used.

Instead of the user identifier and password input by the user, a predetermined authentication device may be used. For example, biometric authentication (fingerprint authentication, vein authentication, etc.) or IC card authentication may be used instead.

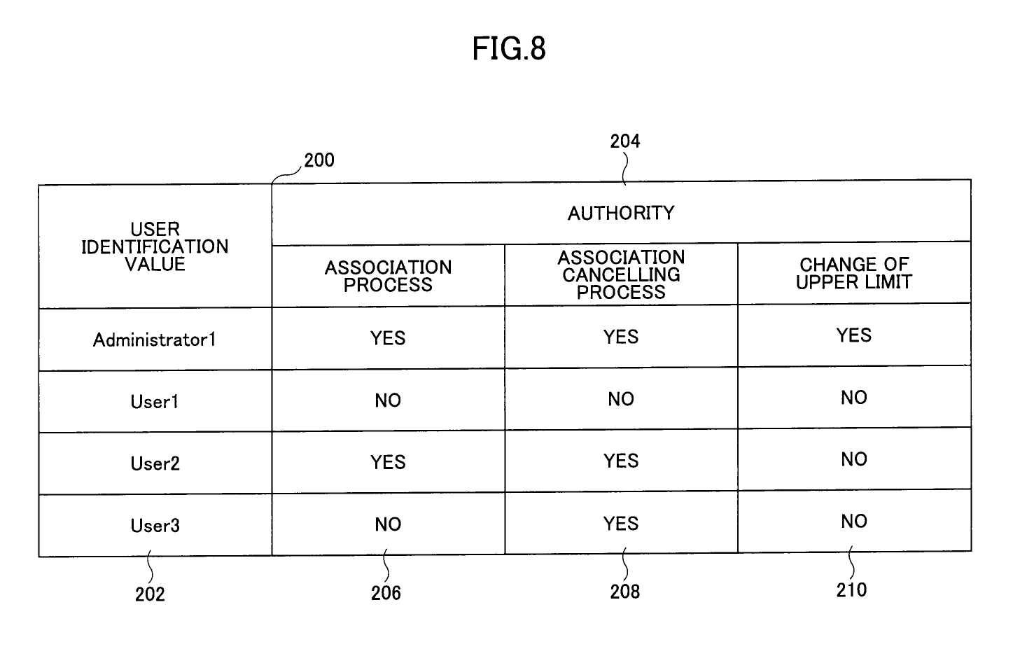

FIG. 8 shows the data structure of the user authority table referred to at the step S302 in the license management process of FIG. 7.

In the user authority table 200 of FIG. 8, the user identifiers, and the execution authority of each of association process, association cancelling process and the upper limit changing process, are associated with each other. The user authority table 200 of FIG. 8 is arranged to include a user-identifier field 202 containing the data entry of the user identifiers, and a set of authority fields 204 containing the data entry of the authority corresponding to the user identifiers.

The set of authority fields 204 is arranged to include three fields 206, 208 and 210 which contain the respective data entries of the execution authority of the three license management processes of “the association process”, “the association cancelling process”, and “the upper limit changing process”.

As shown in FIG. 8, as for the user whose user identifier is “administrator1”, the execution authority for all the license management processes is assigned. On the other hand, as for the user whose user identifier is “user1”, no execution authority for any of the license management processes is assigned.

In the above embodiment, the execution authority of license management process is set up for every user identifier. However, the present invention is not limited to this embodiment. Alternatively, in another embodiment, the execution authority of the license management process is set up comprehensively for a role or title associated with the user identifiers.

In another embodiment, a password may be set up beforehand either collectively or individually for each license management process, and the authority of the user may be determined by the input of that password without performing user authentication.

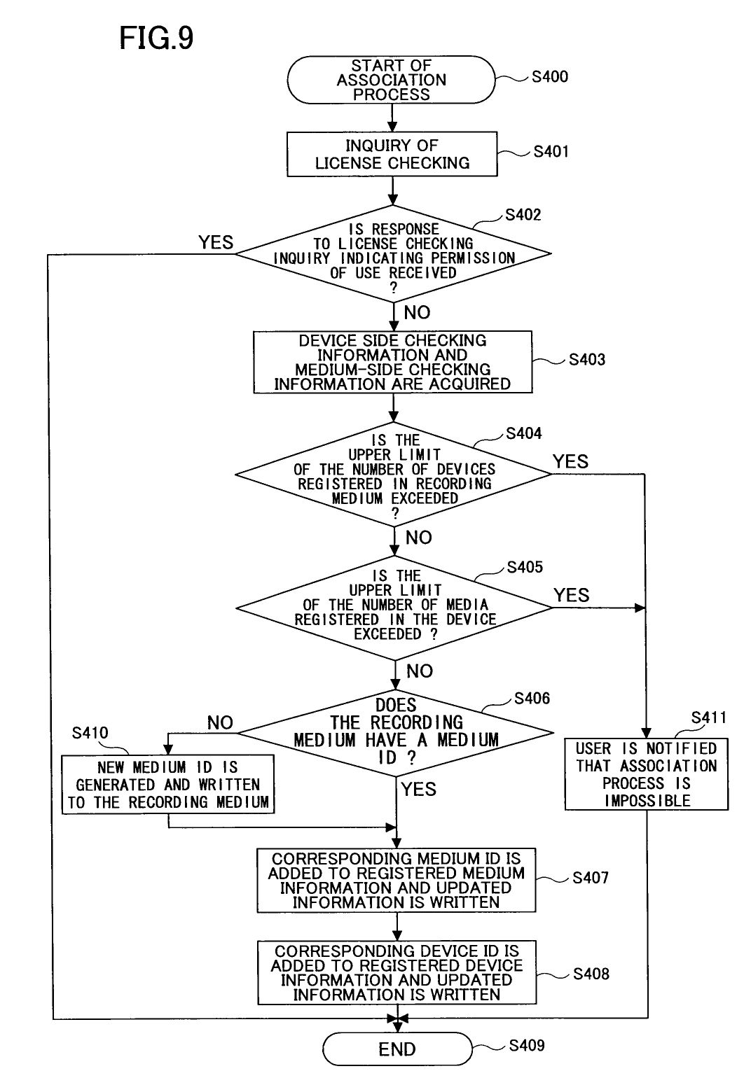

FIG. 9 is a flowchart showing the association process which is performed by the image forming device of this embodiment.

The association process of FIG. 9 is started when a command to execute the association process from the user is received and the association process is called at the step S304 in the process of FIG. 7.

Upon start of the association process of FIG. 9, at step S401, the license managing unit 44 transmits an inquiry of license checking to the checking unit 40.

The license managing unit 44 then receives a response from the checking unit 40. At step S402, the license managing unit 44 determines whether the received response to the license checking inquiry indicates, as the result of the checking, the permission of use of the recording medium in the image forming device 10. When the result of the determination at step S402 is affirmative (YES), there is no necessity of adding a license, and the process is shifted to step S409, at which step the association process is terminated.

On the other hand, when the result of the determination at step S402 is negative (NO), the process is shifted to step S403. At step S403, the license managing unit 44 acquires the device side checking information 50 and the medium side checking information 34. Acquisition of these items of information at this step can be performed by reading them from the recording medium 30 and the NV-RAM 24 again, or by acquiring or receiving the previously acquired device side checking information 50 and medium side checking information 34 from the checking unit 40 through the inter-process communication.

At step S404, the license managing unit 44 determines whether the number of device identifiers which is currently entered into the registered device information 66 in the medium side checking information 34 exceeds the upper limit of the number of devices that can be registered in the recording medium 30, which upper limit is held in the NV-RAM 24.

When the result of the determination at step S404 is affirmative (YES), the process is shifted to step S411. At step S411, the license managing unit 44 reports to the user that since the upper limit of the number of devices that can be registered is exceeded, association cannot be performed. Then, the association process is terminated at step S409.

On the other hand, when the result of the determination at step S404 is negative (NO), the process is shifted to step S405. At step S405, the license managing unit 44 determines whether the number of medium identifiers which is currently entered into the registered medium information 62 in the device side checking information 50 exceeds the upper limit of the number of recording media that can be registered in the image forming device 10, which upper limit is held in the NV-RAM 24.

When the result of the determination at step S405 is affirmative (YES), the process is shifted to the above-mentioned step S411. Similarly, the license managing unit 44 reports at step S411 to the user that since the upper limit of the number of recording media that can be registered is exceeded, association cannot be performed. Then, the association process is terminated at step S409.

On the other hand, when the result of the determination at step S405 is negative (NO), the process is shifted to step S406. At step S406, the license managing unit 44 determines whether the recording medium 30 has a medium ID by making reference to the medium side checking information 34.

When the result of the determination at step S406 is negative (NO), the process is shifted to step S410. At step S410, a new medium ID is generated using a predetermined random-number function or the like, and the new medium ID is written to the recording medium 30. Then, the process is shifted to step S407.

When the result of the determination at step S406 is affirmative (YES), the process is shifted to step S407. At step S407, the license managing unit 44 performs data entry of the corresponding medium ID of the recording medium 30 to the registered medium information 62, updates the data, and stores the updated registered medium information 62 in the NV-RAM 24.

At step S408, the license managing unit 44 performs data entry of the corresponding device ID of the image forming device 10 to the registered device information 66, updates the data, and writes the updated registered device information 66 to the recording medium 30. Then, the association process is terminated at step S409.

As mentioned above, the medium ID is shared and associated between the recording medium 30 and the image forming device 10 by carrying out data entry of the medium ID of the recording medium 30 to the registered medium information 62. At the same time, the device ID is shared and associated between the image forming device 10 and the recording medium 30 by carrying out data entry of the device ID of the image forming device 10 to the registered device information 66 and writing it to the recording medium 30.

Through the determination at the step S404 as to whether the upper limit of the number of devices which can be registered in the recording medium 30 is exceeded, and through the determination at the step S405 as to whether the upper limit of the number of media which can be registered in the image forming device 10 is exceeded, it is possible to prevent the association process from being indefinitely performed.

Through the process at the steps S406 and S410, even when the recording medium 30 has no specific medium ID, a new medium ID is generated. By this configuration, the association process can be carried out even if a specific medium ID is not given beforehand to the recording medium by the vendor or the like.

Alternatively, the process of generating a new medium ID at the steps S406 and S410 may be omitted when the license checking using the medium ID is not performed.

As mentioned above, the association process of FIG. 9 is started when the user command through the operation panel unit 26 is received. The invention is not limited to this embodiment. Alternatively, the association process of FIG. 9 may be arranged as follows. Namely, when it is determined as a result of license checking that the user has no license, the checking of predetermined user authority is performed, and the association process of FIG. 9 is automatically started at the end of the checking of predetermined user authority. In this case, it is possible to increase the convenience for the user.

In the above-mentioned embodiment, the upper limit of the number of devices which can be registered in the recording medium is stored in the NV-RAM 24 of the image forming device 10. The invention is not limited to this embodiment. In another embodiment, the upper limit of the number of devices which can be registered in the recording medium may be stored in the recording medium 30, and it may be acquired from the recording medium 30 in the process of step S403. By this embodiment, it is possible to share the common upper limit among two or more information processing devices.

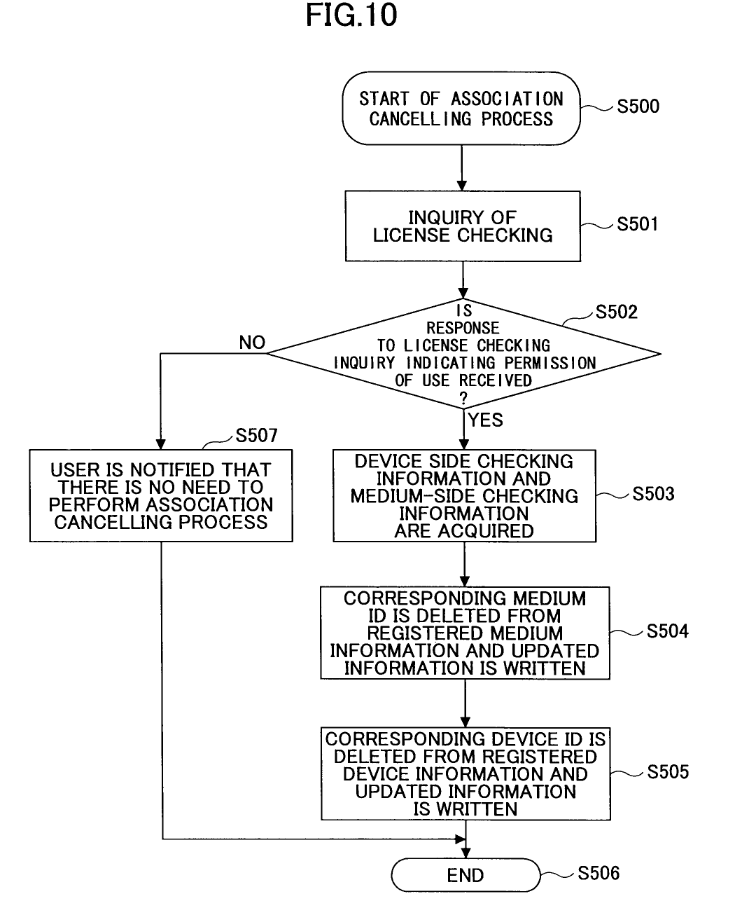

Next, a description will be given of an association cancelling process. FIG. 10 is a flowchart showing the association cancelling process which is performed by the image forming device of this embodiment.

The association cancelling process of FIG. 10 is started at step S500 when a command to execute the association cancelling process is received from the user and the association cancelling process is called at the step S304 in the process of FIG. 7.

Upon start of the process of FIG. 10, the license managing unit 44 at step S501 transmits an inquiry of license checking to the checking unit 40.

After the response is received from the checking unit 40, the license managing unit 44 at step S502 determines whether the received response to the inquiry of license checking indicates the permission of use.

When the result of the determination at step S502 is negative (NO), association of the image forming device 10 and the recording medium 30 is not yet performed and the process is shifted to step S507. At step S507, the license managing unit 44 causes the operation panel unit 26 to display on the display screen a message notifying to the user that there is no need to perform the association cancelling processing, and the process is terminated at step S506.

On the other hand, when the result of the determination at step S502 is affirmative (YES), the received response in this case indicates the permission of use, and the process is shifted to step S503.

At step S503, the license managing unit 44 acquires the device side checking information 50 and the medium side checking information 34.

At step S504, the license managing unit 44 deletes the entry of the medium ID of the recording medium 30 from the registered medium information 62 of the device side checking information 50, and stores the updated registered medium information 62 into the NV-RAM 24.

At step S505, the license managing unit 44 deletes the entry of the device ID of the image forming device 10 from the registered device information 66 of the medium side checking information 34, and writes the updated registered device information 66 to the recording medium 30. Then the association cancelling process is terminated at step S506.

As mentioned above, sharing of the medium ID between the image forming device 10 and the recording medium 30 is lost by deleting the entry of the medium ID of the recording medium 30 from the data of the registered medium information 62 of the device side checking information 50. At the same time, by deleting the entry of the device ID of the image forming device 10 from the data of the registered device information 66 of the medium side checking information 34 and writing the updated data to the recording medium 30, sharing of the device ID between the recording medium 30 and the image forming device 10 is lost. Thereby, the association is cancelled.

The number of remaining devices and the number of remaining recording media which are associated with the image forming device 10 and the recording medium 30 are increased by performing the association cancelling process of FIG. 10, and by using the same together with the association processing of FIG. 9 in which the determination concerning the upper limit of the number of the registration items is performed, it is possible to carry out the license assignment effectively and prevent the license assignment from being performed indefinitely. Moreover, it is possible to make effective use of the memory capacity of the recording medium 30 and the NV-RAM 24.

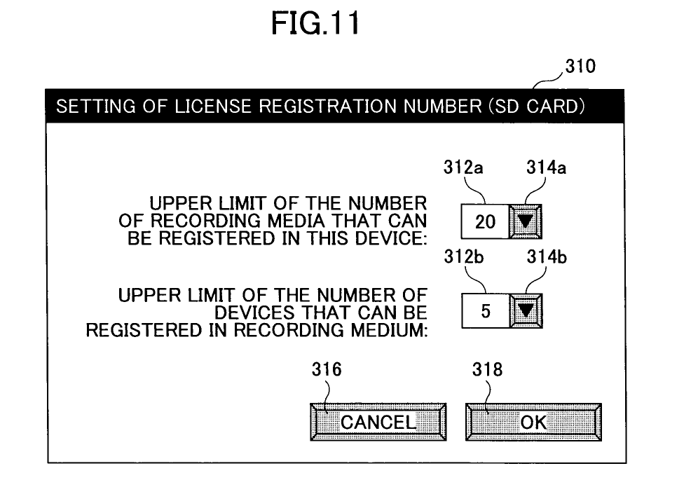

FIG. 11 shows an example of a graphical user interface (GUI) displayed on the display screen of the operation panel unit 26, which is arranged for enabling the user to set up the upper limit of the number of devices which can be registered in the recording medium 10, and the upper limit and recording medium of the number of media which can be registered in the image forming device 10. The upper limits being set up are used in the association process of FIG. 9.

For the sake of convenience of illustration, the case where the operation panel unit 26 is a touch panel will be explained as a typical example.

In the GUI 310 of FIG. 11, the screen of setting of the upper limit of license registration number of SD cards is arranged. Moreover, the GUI 310 is arranged to include a pull-down menu 312a and a button 314a from which a value of the upper limit of the number of recording media which can be registered in the image forming device 10 is input by the user, and a pull-down menu 312b and a button 314b from which a value of the upper limit of the number of devices which can be registered in the recording medium 30 is input by the user.

Moreover, the GUI 310 is arranged to include an OK button 318 from which the command to validate the setup values is input by the user, and a CANCEL button 316 from which the command to cancel the setup values is input by the user.

Data entry of a set of candidate values of the upper limit of the number of recording media is contained in the pull-down menu 312a, and when the user presses the button 314a, the value of the pull-down menu 312a can be changed to another candidate value. Data entry of a set of candidate values of the upper limit of the number of devices is contained in the pull-down menu 312b, and when the user presses the button 314b, the value of the pull-down menu 312b can be changed to another candidate value.

By operating the pull-down menus 312a, 312b and the buttons 314a, 314b, the user selects the upper limit value of the corresponding license registration number and presses the OK 318. Then, the selected value of the upper limit of the corresponding number is set up and written to the NV-RAM 24. Thereby, management and setting of the upper limit of the license registration number is carried out for the image forming device 10 and the recording medium 30, which allows flexible license management.

In the above-mentioned embodiment of the invention, depending on the association between an information processing device and a removable recording medium, the permission of use is given, and performing access control to the removable recording medium is enabled by the permission of use. It is possible to provide an information processing device which is able to perform control use of a removable recording medium with good security and flexibility.

Moreover, in the above-mentioned embodiment of the invention, the permission of use is given only to a recording medium for which the association is already performed, and license checking of the recording medium is performed when it is attached. It is possible to prevent the license assignment from being performed indefinitely by setting up the upper limit of the registration device number and the registration medium number for the recording medium and the information processing device.

In the above-mentioned embodiment, a new medium ID is generated for a recording medium having no specific medium ID, which enables the recording medium having no specific medium ID to be also used. In the above-mentioned embodiment, the function to carry out the association cancelling process is provided, which enables the user to make effective use of the number of recording media to the upper limit, and make effective use of the memory capacity of a recording medium or a memory unit with the information processing device.

In the above-mentioned embodiment, a serial number, a manufacture serial number, an identification number, etc. which are given to each information processing device by the vendor may be used as the device ID (identifier), and as long as the information processing device can be identified suitably, any kind of device ID may be used. Similarly, as long as the recording medium can be identified suitably, any of a serial number, a manufacture serial number, an identification number, etc. which are given to each recording medium by the vendor may be used as the medium ID (identifier).

In the above-mentioned embodiment, an image forming device, such as a multi-function peripheral, is arranged as the information processing device of the invention. Alternatively, in accordance with specific applications, any of the following devices may be arranged as the information processing device of the invention if the information processing device is capable of using a removable recording medium to read or write the information stored therein: personal computers, servers, copiers, printers, image readers, cellular phones, PDAs, portable electronic game devices, scanners, audio/video input-output devices, imaging devices, digital cameras, digital camcorders, television sets, HDD recorders, audio terminals, in-vehicle electronic devices, digital-appliance apparatus, car navigation systems, etc.

Regarding the removable recording medium used in the information processing device of the invention, it is not limited to SD memory card, but it may be any of removable recording media, such as Compact Flash® memory card, Smart Media®, Memory Stick (registered trademark), xD Picture Card, and others which are used solely or in combination.

The above-mentioned functions in the information processing device of the invention may be performed by using any computer-readable program described in a legacy programming language, such as assembly language, C, C++, C#, Java (registered trademark), or an object-oriented programming language, etc. And the computer-readable program may be distributed with any computer-readable recording medium on which the program is recorded, such as ROM, EEPROM, EPROM, flash memory, flexible disk, CD-ROM, CD-RW, DVD, SD card, and MO.

The present invention is not limited to the above-described embodiments, and variations and modifications may be made without departing from the scope of the present invention.

The present application is based on and claims the benefit of priority of Japanese patent application No. 2007-066760, filed on Mar. 15, 2007, the contents of which are incorporated by reference in their entirety.

What is claimed is:

1. An information processing device which uses a removable recording medium, comprising:
a storing unit in which registered medium information is stored, indicating a set of registered recording media, use of which in the information processing device is permitted;
a checking unit for checking usability of a removable recording medium attached to the information processing device, by comparing the registered medium information from the storing unit with registered device information acquired from the recording medium attached to the information processing device and indicating a set of registered information processing devices each of which permits use of the recording medium in the registered information processing device; and
a usability control unit managing use of the recording medium in the information processing device according to a result of the checking by the checking unit.

2. The information processing device according to claim 1, wherein the checking unit retrieves a device identifier of the information processing device from the acquired registered device information and sets the result of the checking to indicate a permission of use of the recording medium when the device identifier is found.

3. The information processing device according to claim 1, wherein the checking unit retrieves a medium identifier of the recording medium acquired from the recording medium, from the registered medium information from the storing unit, and sets the result of the checking to indicate the permission of use of the recording medium when the medium identifier is found.

4. The information processing device according to claim 2, wherein the usability control unit permits reading data from the recording medium or writing data to the recording medium when the result of the checking is set to indicate the permission of use of the recording medium.

5. The information processing device according to claim 2, further comprising a reading unit reading a predetermined data from the recording medium when the result of the checking is set to indicate the permission of use of the recording medium.

6. The information processing device according to claim 1, further comprising a managing unit adding a medium identifier of the recording medium to the registered medium information and writing a device identifier of the information processing device to the recording medium, so that association process is performed to associate the recording medium with the information processing device.

7. The information processing device according to claim 6, wherein the managing unit is arranged to determine whether the association process is to be performed, by using at least one of an upper limit of the number of the registered information processing devices and an upper limit of the number of the registered recording media.

8. The information processing device according to claim 6, wherein the managing unit is arranged to delete a medium identifier of the recording medium from the registered medium information and delete a device identifier of the information processing device from the recording medium, so that an association cancelling process is performed to cancel association of the recording medium from the information processing device.

9. The information processing device according to claim 6, further comprising an authority information storing unit in which authority management information relating to authority of execution of a process by the managing unit is stored, and an authority managing unit which determines whether execution of the process by the managing unit is permitted, according to the authority management information.

10. A multi-function peripheral which uses a removable recording medium, comprising:
a storing unit in which registered medium information is stored, indicating a set of registered recording media uses, which uses are permitted by the multi-function peripheral;
a checking unit checking usability of a removable recording medium attached to the multi-function peripheral by comparing the registered medium information from the storing unit with registered device information acquired from the recording medium attached to the multi-function peripheral and indicating a set of registered multi-function peripherals, each of which permits use of the recording medium in the registered multi-function peripheral; and
a usability control unit managing use of the recording medium in the multi-function peripheral according to a result of the checking by the checking unit.

11. An information processing method for an information processing device which uses a removable recording medium, the method comprising:
storing registered medium information into the information processing device, indicating a set of registered recording media uses, which uses are permitted by the information processing device;
checking usability of a removable recording medium attached to the information processing device by comparing the registered medium information with registered device information acquired from the recording medium attached to the information processing device and indicating a set of registered information processing devices, each of which permits use of the recording medium in the registered information processing device; and
managing use of the recording medium in the information processing device according to a result of the checking.
